(19) United States
(12) Patent Application Publication
(10) Pub. No.: US 2008/0204376 A1
(43) Pub. Date: Aug. 28, 2008

(54) AMOLED INCLUDING CIRCUIT TO SUPPLY ZERO DATA VOLTAGE AND METHOD OF DRIVING THE SAME

(75) Inventors: Jong-hak Baek, Seoul (KR); Han-Su Pae, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/037,276

(22) Filed: Feb. 26, 2008

(30) Foreign Application Priority Data
Feb. 27, 2007 (KR) 2007-19922

(51) Int. Cl. G09G 3/30

(52) U.S. Cl. 345/76

(57) ABSTRACT

An active matrix organic electroluminescent display including a circuit to supply a zero data voltage, and a method of driving thereof. A driver of the organic electroluminescent display includes a zero data process block which outputs a zero data voltage enable signal when pixel data that is to be displayed is zero data, and a circuit to transmit zero data voltage corresponding to the zero data to a pixel in response to the zero data voltage enable signal. The organic electroluminescent display and the driver thereof separately include the circuit for supplying zero data voltage, and thus zero data can be accurately displayed.

### CROSS-REFERENCE TO RELATED APPLICATIONS

This application claims priority under 35 U.S.C. §119(a) from Korean Patent Application No. 10-2007-0019922, filed on Feb. 27, 2007, in the Korean Intellectual Property Office, the disclosure of which is incorporated herein in its entirety by reference.

### BACKGROUND OF THE INVENTION

1. Field of the Invention

The present general inventive concept relates to a display, and more particularly, to an active matrix organic electroluminescent display (AMOLED) including a circuit to supply zero data voltage, and a method of writing zero data using the same.

2. Description of the Related Art

A liquid crystal display (LCD) is thin and has low power consumption. However, an LCD is not luminous and thus requires a backlight.

In order to make up for the weak points of LCDs, an organic electroluminescent (EL) display has come into the spotlight. An organic electroluminescent display emits light by electrically exciting an organic phosphor, and thus a separate light source is not required.

Accordingly, an organic electroluminescent display is thin and can be driven at a low voltage, and is recognized as a strong next generation display which can be used in many electronic devices, such as mobile communication terminals, camcorders, etc.

Organic electroluminescent displays can be classified into passive matrix types and active matrix types. A passive matrix type organic electroluminescent display has a simple structure and manufacturing process but has low display capacity since as the number of wirings increases, and thus its aperture ratio deteriorates. Meanwhile, An active matrix type organic electroluminescent display has high luminance efficiency and high resolution.

FIG. 1 is a circuit diagram illustrating a unit pixel circuit PIX of a conventional organic electroluminescent display.

Referring to FIG. 1, the unit pixel circuit PIX includes a switching transistor M1, a capacitor C, a current driving transistor M4, and an organic electroluminescent device OLED between a scan line S and a data line D. A gate of the switching transistor M1 is connected to the scan line S, and a source of the switching transistor M1 is connected to the data line D. One terminal of the capacitor C is connected to a drain of the switching transistor M1 and another terminal is connected to the ground GND. A drain of the current driving transistor M4 is connected to a cathode of the organic electroluminescent device OLED, to which a driving voltage VDD is applied, a gate of the current driving transistor M4 is connected the drain of the switching transistor M1, and a source of the current driving transistor M4 is connected the ground GND.

FIG. 2 is a timing diagram illustrating the operation of the unit pixel circuit PIX of FIG. 1.

Referring to FIGS. 1 and 2, when a first voltage VGH is applied to the scan line S, the switching transistor M1 is turned on. When the switching transistor M1 is turned on, charge is accumulated in the capacitor C by a data voltage Vdata applied to the data line D.

Then, when a second voltage VGL is applied to the scan line S, the switching transistor M1 is turned off, and the capacitor C maintains the accumulated charge. The current flowing through the current driving transistor M4 is determined according to a difference between the voltage charged in the capacitor C and the driving voltage VDD.

The organic electroluminescent device OLED emits light corresponding to the current flowing through the current driving transistor M4. That is, the amount of light emitted by the organic electroluminescent device OLED is determined by the current corresponding to a voltage according to pixel data (image data).

However, when the capacitor C is directly charged by a voltage applied to the data line D as illustrated in the unit pixel circuit PIX of FIG. 1, problems occur in an organic electroluminescent display in terms of development and mass production due to a characteristic deviation of a thin film transistor (TFT), that is, a deviation of a threshold voltage and a mobility of the TFT. This is because despite applying the same voltage to each data line D, the current flowing through the current driving transistor M4 is different due to a characteristic variation of the TFT.

Due to the characteristic variation of the TFT, a mura phenomenon occurs on a screen. In order to decrease the characteristic deviation of a TFT, an organic electroluminescent display using a current sink method has been developed. Hereinafter, an active matrix type organic electroluminescent display will be referred to as an AMOLED.

FIG. 3 is a circuit diagram illustrating a unit pixel circuit PIX of an AMOLED 300 using a current sink method.

Referring to FIG. 3, the unit pixel circuit PIX is located between a scan line S and a data line D, and includes switching transistors M1 and M2, a capacitor C, a charging transistor M3, a current driving transistor M4, and an organic electroluminescent device OLED. In FIG. 3, each transistor is a PMOS transistor.

When the scan line S is activated, the switching transistors M1 and M2 are turned on. When the switching transistors M1 and M2 are turned on, a current equal to the current Idata, sunk according to corresponding data, flows through the charging transistor M3. The current Idata sinks by a current digital analog converter (DAC) (not illustrated) of a driver DRIV indicated by a dotted line, according to the corresponding data. When the charging transistor M3 activates, the capacitor C is charged with a gate bias voltage of the charging transistor M3.

When the scan line S is deactivated, the switching transistors M1 and M2 are turned off and the charge accumulated in the capacitor C is maintained. Here, the current flowing to the current driving transistor M4 is proportional to a capacitor voltage Vc. In other words, a current proportional to a difference between the driving voltage VDD and a voltage of node A is supplied to the organic electroluminescent device OLED. Like the organic electroluminescent display of FIG. 1, the amount of light emitted from the organic electroluminescent device OLED is determined according to the current flowing through the driving transistor M4.

A characteristic deviation in the threshold voltage of a TFT in the AMOLED 300 using a current sink method of FIG. 3 is self-compensated. Even when the threshold voltage in a transistor of each unit pixel circuit PIX varies, the voltage of a node A is uniformly maintained since the charging transistor M3 is diode connected. That is, the AMOLED using a current sink method can supply the same sink current to the current driving transistor M4 irrespective of a characteristic deviation of a TFT. However, the AMOLED using a current sink method has the following disadvantages.

First, a current corresponding to low gray scale image data cannot be written to a pixel within a line time. In order to display the low gray scale image data, a current of several nA or tens of nA is required. That is, the difference between the driving voltage VDD and the voltage of the node A should be small. For example, when the driving voltage VDD is 5 V and the threshold voltage of the current driving transistor M4 is 1 V, the voltage of the node A should be between 3.5 V to 4 V in order to generate a current corresponding to a low gray scale. That is, in order to supply the current corresponding to a low gray scale to the organic electroluminescent device OLED, a voltage above a predetermined level should be applied to the node A.

However, when pixel data of a previous frame has a high gray scale, a lot of time is consumed for the voltage of the node A to reach the voltage required for low gray scale pixel data. Accordingly, it is difficult to write the low gray scale image data within a line time.

Second, zero data (“0”) cannot be written. When pixel data is “0”, the current driving transistor M4 is turned off in order to block the current supplied to the organic electroluminescent device OLED. As described above, the current driving transistor M4 is turned off when the voltage of the node A exceeds 4 V.

However, when the pixel data is “0”, all current DACs of the driver DRIV float. The operation of a current DAC will be described in detail later with reference to FIG. 6. The driver DRIV does not operate when the pixel data is “0”.

In order to solve the disadvantages of the AMOLED using a current sink method, a precharging scheme is used. The driver DRIV using the precharging scheme applies a precharge voltage to the node A when the scan line S is activated. Accordingly, the voltage of the node A can quickly reach the voltage corresponding to the low gray scale pixel data.

However, in the conventional AMOLED, pixel data may be “0”, and thus the precharge voltage cannot be set to a required level, because the conventional AMOLED displays “0” using the precharge voltage. In other words, “0” is displayed by supplying a current corresponding to the difference between the driving voltage VDD and the precharge voltage to the organic electroluminescent device OLED.

Accordingly, the conventional AMOLED still cannot write the low gray scale pixel data within the line time. Also, by using the precharge voltage as a zero data voltage, “0” (black data) cannot be accurately displayed.

### SUMMARY OF THE INVENTION

The present general inventive concept provides an active matrix organic electroluminescent display (AMOLED) which can quickly write low gray scale image data by performing precharging and can accurately write zero data (black data), and a driver thereof.

The present general inventive concept also provides a method of driving an AMOLED, particularly a method of writing zero data.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a driver of an organic electroluminescent display, the driver including a zero data process block which outputs a zero data voltage enable signal when pixel data that is to be displayed is zero data, and a circuit to transmit a zero data voltage corresponding to the zero data to a pixel corresponding to the pixel data in response to the zero data voltage enable signal. The organic electroluminescent display may be driven using a current sink method.

The circuit to transmit the zero data voltage may include a switching unit having one terminal applied with the zero data voltage and another terminal connected to an output node of the driver. The switching unit may be a PMOS transistor.

The driver may further include a current digital analog converter which sinks a current corresponding to the pixel data from the pixel. The current digital analog converter may include: switches which correspond to each bit of the pixel data; and transistors which are connected between corresponding switches and a ground node.

The driver may further include a precharging circuit which applies a precharge voltage to the pixel in response to a precharge enable signal. The precharge voltage may be higher than the zero data voltage. The precharging circuit may include a switching unit having one terminal applied with the precharge voltage and another terminal connected to an output node of the driver.

The driver may further include a data latch circuit which receives the pixel data and then transmits the pixel data to the zero data process block.

The zero data voltage may be a panel voltage. The organic electroluminescent display may be an active matrix organic electroluminescent display.

The foregoing and/or other aspects and utilities of the present general inventive concept may also be achieved by providing an organic electroluminescent display device including a driver including a zero data process block which outputs a zero data voltage enable signal when pixel data that is to be displayed is zero data, and a circuit to transmit a zero data voltage corresponding to the zero data to a pixel corresponding to the pixel data in response to the zero data voltage enable signal. The organic electroluminescent display may be driven using a current sink method.

The organic electroluminescent display device may include unit pixel circuits which are disposed in a corresponding pixel between a scan line and a data line, and each unit pixel circuit may include a switching transistor which is turned on in response to an activation of the scan line, a charging transistor having a gate connected to a first node, one terminal connected to the switching transistor, and another terminal applied with a driving voltage, a capacitor having a terminal applied with the driving voltage and another terminal connected to the first node, a current driving transistor having a gate connected to the first node and one terminal applied with the driving voltage, and an organic electroluminescent device which is connected to another terminal of the current driving transistor. The capacitor may be charged with the zero data voltage, when the zero data voltage enable signal is applied to the pixel.

The foregoing and/or other aspects and utilities of the present general inventive concept may also be achieved by providing a driver of an organic electroluminescent display, the driver including: a circuit to supply a precharge voltage which applies a precharge voltage to a pixel circuit of the organic electroluminescent display; a current digital analog converter which sinks a current corresponding to pixel data that is to be displayed from the pixel circuit, when the pixel data is not zero data, and a circuit to supply a zero data voltage corresponding to the zero data to the pixel circuit when the pixel data is zero data.

The foregoing and/or other aspects and utilities of the present general inventive concept may also be achieved by providing a method of driving an organic electroluminescent display, the method including: receiving pixel data that is to be displayed, determining whether the pixel data is zero data, and applying a zero data voltage corresponding to the zero data to a pixel corresponding to the pixel data when the pixel data is zero data.

The method may further include activating a scan line where the pixel is located, and precharging the pixel with a precharge voltage. The method may further include sinking a current corresponding to the pixel data when the pixel data is not zero data.

The foregoing and/or other aspects and utilities of the present general inventive concept may also be achieved by providing a driver of an organic electroluminescent display, the driver including a first circuit to supply a current to a pixel circuit when pixel data is not zero data, and a second circuit to supply a zero data voltage to the pixel circuit when the pixel data is zero data.

The first circuit may generate the current according to a current sink method.

The second circuit may not generate the voltage according to a current sink method.

The first circuit and the second circuit generate the current and the zero data voltage according to different methods.

The driver may further include a data line connected to the panel circuit, the first circuit may be connected between a first power source and the data line to supply the current to the data line, and the second circuit may be connected between a second power source and the data line to supply the zero data voltage to the data line.

The foregoing and/or other aspects and utilities of the present general inventive concept may also be achieved by providing an organic electroluminescent display, including a panel circuit to drive a panel, and a driver connected to the panel circuit, and including a first circuit to supply a current to a pixel circuit when pixel data is not zero data, and a second circuit to supply a zero data voltage to the pixel circuit when the pixel data is zero data.

The foregoing and/or other aspects and utilities of the present general inventive concept may also be achieved by providing a driver of an organic electroluminescent display, the driver including a zero data process block which outputs a zero data voltage enable signal when pixel data that is to be displayed is zero data, a circuit to transmit a zero data voltage corresponding to the zero data to a pixel circuit in response to the zero data voltage enable signal, a circuit to supply precharge voltage to the pixel circuit according to the pixel data, and a current digital analog converter which sinks a current corresponding to the pixel data that is to be displayed from the pixel circuit, when the pixel data is not zero data.

The foregoing and/or other aspects and utilities of the present general inventive concept may also be achieved by providing an organic electroluminescent display, including a panel circuit to drive a panel, and a driver connected to the panel circuit, the driver comprising: a zero data process block which outputs a zero data voltage enable signal when pixel data that is to be displayed is zero data, a circuit to transmit a zero data voltage corresponding to the zero data to a pixel circuit in response to the zero data voltage enable signal, a circuit to supply precharge voltage to the pixel circuit according to the pixel data, and a current digital analog converter which sinks a current corresponding to the pixel data that is to be displayed from the pixel circuit, when the pixel data is not zero data.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a circuit diagram illustrating a unit pixel circuit of a conventional organic electroluminescent display;

FIG. 2 is a timing diagram illustrating an operation of the unit pixel circuit of FIG. 1;

FIG. 3 is a circuit diagram illustrating a unit pixel circuit of an active matrix organic electroluminescent display (AMOLED) using a current sink method;

FIG. 4 is a diagram illustrating a driver of an organic electroluminescent display according to an embodiment of the present general inventive concept;

FIG. 5 is a diagram illustrating an organic electroluminescent display according to an embodiment of the present general inventive concept;

FIG. 6 is a circuit diagram illustrating an output terminal of the driver of FIGS. 4 and 5;

FIG. 7 is a flowchart illustrating a method of driving an organic electroluminescent display according to an embodiment of the present general inventive concept; and

FIG. 8 is a flowchart illustrating a method of driving an organic electroluminescent display according to another embodiment of the present general inventive concept.

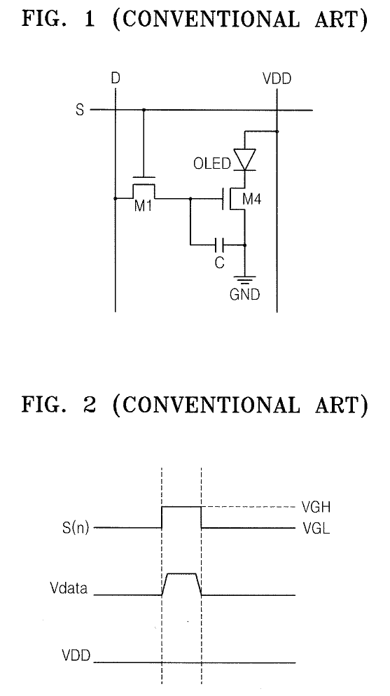

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

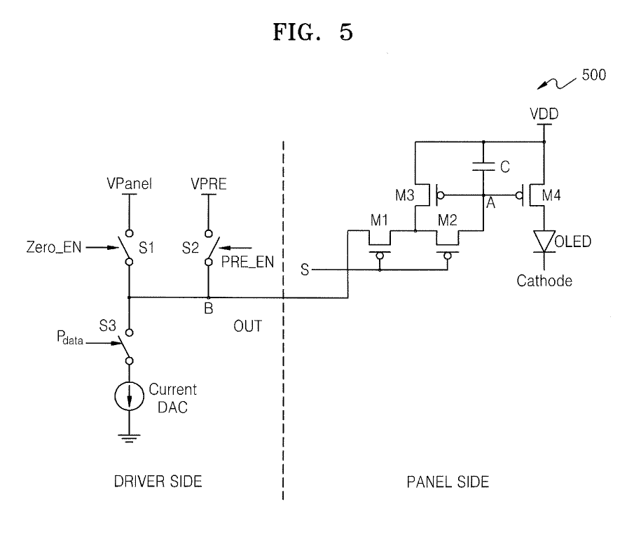

FIG. 4 is a diagram illustrating a driver DRIV of an organic electroluminescent display according to an embodiment of the present general inventive concept. FIG. 5 is a diagram illustrating an organic electroluminescent display 500 according to an embodiment of the present general inventive concept. The organic electroluminescent display according to the current embodiment may be an active matrix type organic electroluminescent display. Also, the organic electroluminescent display according to the current embodiment may be driven by a current sink method.

Hereinafter, it is assumed that the present general inventive concept is an active matrix type organic electroluminescent display driven by a current sink method. Also, the active matrix type organic electroluminescent display will be referred to as an AMOLED herein.

Referring to FIGS. 4 and 5, the AMOLED 500 according to the current embodiment includes a driver DRIV and a unit pixel circuit PIX. The driver DRIV includes a zero data process block 420, a circuit ZeroU to transmit zero data voltage, a data latch circuit 440, and a current digital analog converter (DAC) 460.

When pixel data Pdata is received, a scan line S is activated. The activation of the scan line S depends on a scan driver (not illustrated). The data latch circuit 440 receives the pixel data Pdata and transmits the pixel data Pdata to the zero data process block 420 and the current DAC 460. Zero data is data having a “0” value, and is displayed in black on a screen. Accordingly, the zero data is also called black data.

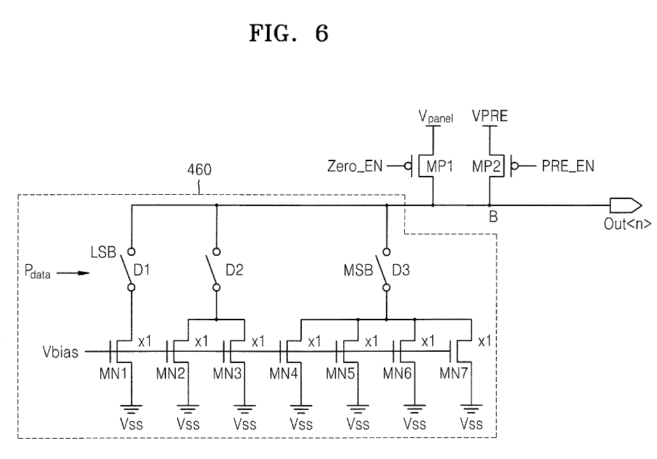

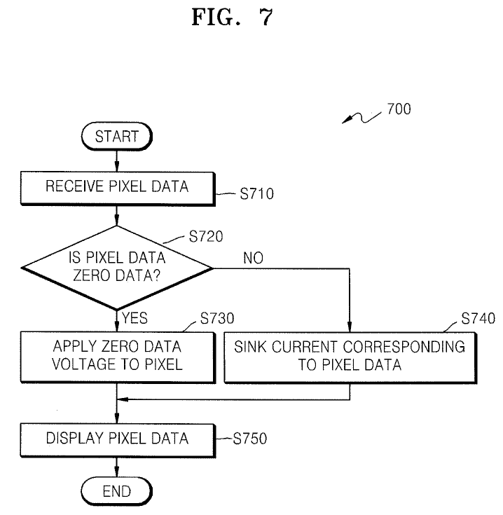

When the pixel data Pdata is not zero data, the current DAC 460 starts to operate. FIG. 6 is a circuit diagram of an output terminal of the driver DRIV of FIGS. 4 and 5. In particular, FIG. 6 illustrates a current sink type binary weight current DAC.

Referring to FIG. 6, the current DAC 460 includes switches D1 through D3 (S3 of FIGS. 4 and 5) corresponding to each bit of the pixel data Pdata, and transistors MN1 through MN7 connected between a corresponding switch and a ground node. The transistors MN1 through MN7 may be NMOS transistors. For convenience, the current DAC 460 of FIG. 6 is illustrated as a binary weight current DAC in 3 bits.

The switches D1 through D3 of the current DAC 460 is turned on and off in response to a bit corresponding to the pixel data Pdata. A current corresponding to a gray scale of the pixel data Pdata sinks from the pixel or the unit pixel circuit PIX of FIG. 5 by an NMOS transistor corresponding to the turned on switch. In other words, the current corresponding to a gray scale of the pixel data Pdata sinks from a data line D connected to the unit pixel circuit PIX. Hereinafter, the current sunk by the current DAC 460 will be referred to as a sink current.

The sink current is generated when the pixel data Pdata is not zero data, and thus an organic electroluminescent device OLED of the unit pixel circuit PIX of FIG. 5 starts to operate. The operation of the unit pixel circuit PIX according to the sink current will now be described in detail.

Referring to FIG. 5, the unit pixel circuit PIX of the AMOLED 500 according to the current embodiment includes a switching transistor M1, a charging transistor M3, a capacitor C, a current driving transistor M4, and the organic electroluminescent device OLED. The switching transistor M1 is turned on in response to the activation of the scan line S.

The charging transistor M3 has a gate connected to a first node A, one terminal connected to the switching transistor M1, and another terminal to which a driving voltage VDD is applied. Accordingly, when the switching transistor M1 is turned on, a voltage which is applied to the scan line S, is applied to the gate of the charging transistor M3, and thus the charging transistor M3 is turned on.

When the charging transistor M3 is turned on, a current corresponding to the sink current flows through the charging transistor M3. In the capacitor C, the driving voltage VDD is applied to one terminal and another terminal is connected to the first node A. Accordingly, when the sink current flows through the charging transistor M3, a gate bias voltage of the charging transistor M3 is charged in the capacitor C.

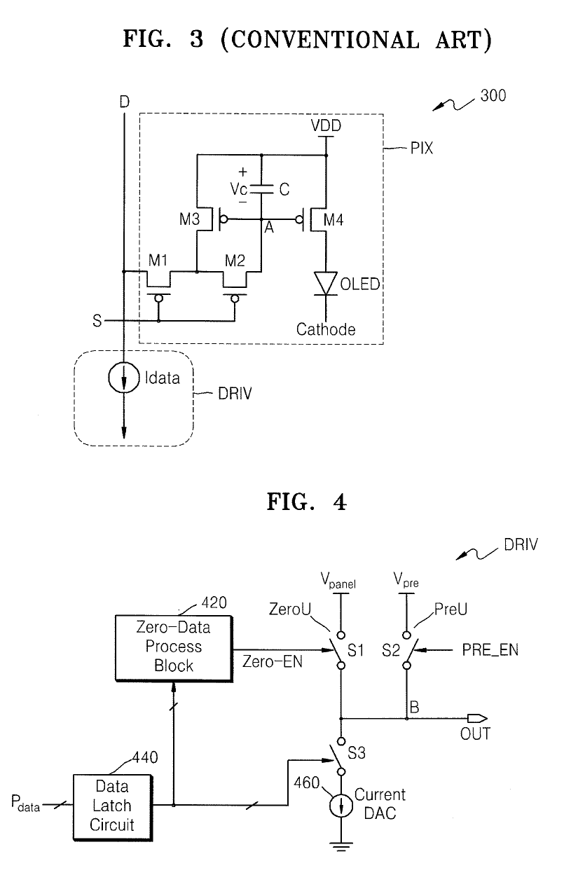

A conventional unit pixel circuit PIX of FIG. 3 can be used as the unit pixel circuit PIX of FIG. 5. Accordingly, when the scan line S is deactivated, the charge in the capacitor C is maintained during a predetermined time. In the current driving transistor M4, a gate is connected to the first node A and the driving voltage VDD is applied to one terminal. Accordingly, a current proportional to the difference between the driving voltage VDD and a capacitor voltage Vc flows through the current driving transistor M4.

The current flowing through the current driving transistor M4 affects the luminescence of the organic electroluminescent device OLED, connected to another terminal of the current driving transistor M4. In other words, by the current DAC 460 sinking a current corresponding the pixel data Pdata, the sink current flows through the charging transistor M3 in order to charge the capacitor C with a voltage corresponding to the sink current, and the organic electroluminescent device OLED emits an amount of light corresponding to the capacitor voltage Vc.

Meanwhile, when the pixel data Pdata is zero data, the zero data process block 420 outputs a zero data voltage enable signal Zero_EN. The circuit ZeroU to transmit zero data voltage applies a zero data voltage Vpanel corresponding to the zero data to a pixel corresponding to the pixel data Pdata in response to the zero data voltage enable signal Zero_EN.

Here, the zero data voltage Vpanel corresponding to the zero data turns off the current driving transistor M4 of FIG. 5. This is because the current supplied to the organic electroluminescent device OLED should be cut off when the pixel data Pdata is the zero data as described above. Accordingly, the zero data voltage Vpanel corresponding to zero data may be a panel voltage. The panel voltage is a voltage used in a panel of the AMOLED 500.

The circuit ZeroU to transmit the zero data voltage may include a switching unit S1 having one terminal applied with the zero data voltage Vpanel, and another terminal connected to an output node B of the driver DRIV. The switching unit S1 may be a PMOS transistor MP1.

The PMOS transistor MP1 is turned on in response to the zero data voltage enable signal Zero_EN, and the zero data voltage Vpanel is applied to the unit pixel circuit PIX of FIG. 5. Here, as described above, when the current DAC 460 receives the zero data, the switches D1 through D3 are all turned off, and therefore does not operate (refer to FIG. 6).

When the zero data voltage Vpanel is applied to the unit pixel circuit PIX, the zero data voltage Vpanel is charged in the capacitor C. Accordingly, the current driving transistor M4 is turned off, and thus the zero data (black data) is displayed on the screen.

Referring to FIGS. 5 and 6, the driver DRIV according to the current embodiment may further include a precharging circuit PreU. The precharging circuit PreU may include a switching unit S2 having one terminal applied with a precharge voltage Vpre and another terminal connected to the output node B of the driver DRIV. The switching unit S2 may be a PMOS transistor MP2.

The precharging circuit PreU applies the precharge voltage Vpre to the unit pixel circuit PIX in response to a precharge enable signal PRE_EN. The charge corresponding to the precharge voltage Vpre is applied to the unit pixel circuit PIX to charge the capacitor C. Here, the precharge voltage Vpre may be lower than the zero data voltage Vpanel.

The precharge enable signal PRE_EN can be generated by a driver, for example, the scan line driver or the data line driver, according to the Pdata or according to the activation of the scan line S. The precharge enable signal PRE_EN can be generated when the pixel data Pdata is a low gray scale image or an image to reach a desired voltage before the zero data voltage Vpanel corresponding to the zero data is applied.

The circuit ZeroU applies the zero data voltage Vpanel to the unit pixel circuit PIX after the precharging circuit PreU applies the precharge voltage Vpre to the unit pixel circuit PIX. A conventional precharging circuit can be used as the circuit ZeroU, and a convention control method of a conventional precharging circuit can also be used as a controlling method of the circuit ZeroU. However, the conventional controlling method of the conventional precharging circuit can be changed or modified according to a controlling method of the circuit ZeroU to apply the zero data voltage Vpanel to the unit pixel circuit PIX with respect to the application of the precharge voltage Vpre, so that the black data (zero data) and low gray scale image data can be properly desirably displayed according to the present general inventive concept.

As described above, the AMOLED 500 and the driver DRIV according to the current embodiment independently include a circuit to supply zero data, and thus the zero data can be accurately displayed, the precharge voltage Vpre can be set in a sufficient level, and the low gray scale image data can be displayed within a line time.

FIG. 7 is a flowchart illustrating a method 700 of driving an organic electroluminescent display according to an embodiment of the present general inventive concept.

Referring to FIG. 7, the method 700 includes receiving pixel data that is to be displayed at operation S710, determining whether the pixel data is zero data at operation S720, and applying zero data voltage corresponding to the zero data to a panel of the organic electroluminescent display at operation S730 when the pixel data is the zero data.

The method 700 may further include sinking a current corresponding to the pixel data at operation S740 when the pixel data is not the zero data.

When the zero data voltage or a current corresponding to the sunk current is applied to an organic electroluminescent device, the organic electroluminescent device emits light. When the organic electroluminescent device emits light, the pixel data is displayed on a pixel in operation S750.

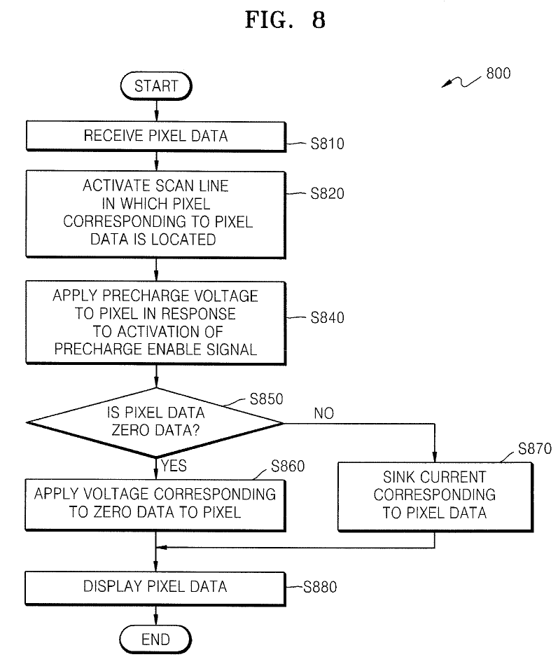

FIG. 8 is a flowchart illustrating a method 800 of driving an organic electroluminescent display according to another embodiment of the present general inventive concept.

Referring to FIG. 8, the method 800 includes receiving pixel data at operation S810 and the received data activating a scan line, in which a pixel that is to be displayed is located at operation S820. Also, the method 800 further includes precharging the pixel with a precharge voltage at operation S840 when a precharge enable signal is activated. Operations S850, S860, S870, and S880 according to a pixel data value are the same as operations S720 through to S750 of the method 700 illustrated in FIG. 7.

The methods of driving an organic electroluminescent display according to the embodiments of the present general inventive concept have the same technical concept as the organic electroluminescent display and the driver thereof described above. Accordingly, one of ordinary skill in the art will be able to understand the methods referring to the descriptions of the organic electroluminescent display and the driver thereof, and thus a detailed description of the methods will be omitted herein.

As described above, the organic electroluminescent display and the driver thereof independently include a circuit for supplying zero data, and thus the zero data can be accurately displayed.

Also, the organic electroluminescent display and the driver thereof independently include a circuit to supply zero data, and thus a precharge voltage can be set to a sufficient level, accordingly displaying low gray scale image data within a line time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A driver of an organic electroluminescent display, the driver comprising:
a zero data process block which outputs a zero data voltage enable signal when pixel data that is to be displayed is zero data; and
a circuit to transmit a zero data voltage, which applies a zero data voltage corresponding to the zero data to a pixel corresponding to the pixel data in response to the zero data voltage enable signal.

2. The driver of claim 1, wherein the organic electroluminescent display is driven using a current sink method.

3. The driver of claim 2, wherein the circuit to transmit the zero data voltage comprises a switching unit having one terminal applied with the zero data voltage and another terminal connected to an output node of the driver.

4. The driver of claim 3, wherein the switching unit is a PMOS transistor.

5. The driver of claim 2, further comprising:
a current digital analog converter which sinks a current corresponding to the pixel data from the pixel.

6. The driver of claim 5, wherein the current digital analog converter comprises:
one or more switches which correspond to each bit of the pixel data; and
one or more transistors which are connected between corresponding switches and a ground node.

7. The driver of claim 2, further comprising:
a precharging circuit which applies a precharge voltage to the pixel in response to a precharge enable signal.

8. The driver of claim 7, wherein the precharge voltage is higher than the zero data voltage.

9. The driver of claim 7, wherein the precharging circuit comprises a switching unit having one terminal applied with the precharge voltage and another terminal connected to an output node of the driver.

10. The driver of claim 9, wherein the switching means is a PMOS transistor.

11. The driver of claim 1, further comprising:
a data latch circuit which receives the pixel data and then transmits the pixel data to the zero data process block.

12. The driver of claim 1, wherein the zero data voltage is a panel voltage.

13. The driver of claim 1, wherein the organic electroluminescent display is an active matrix organic electroluminescent display.

14. An organic electroluminescent display device comprising:
a driver comprising:
a zero data process block which outputs a zero data voltage enable signal when pixel data that is to be displayed is zero data; and
a circuit to transmit a zero data voltage, which applies a zero data voltage corresponding to the zero data to a pixel corresponding to the pixel data in response to the zero data voltage enable signal.

15. The organic electroluminescent display device of claim 14, wherein the pixel is driven by a current sink method.

16. The organic electroluminescent display device of claim 15, comprising:
unit pixel circuits which are disposed in a corresponding pixel between a scan line and a data line,
wherein each unit pixel circuit comprises:
a switching transistor to be turned on in response to an activation of the scan line;
a charging transistor having a gate connected to a first node, one terminal connected to the switching transistor, and another terminal applied with a driving voltage;
a capacitor having one terminal applied with the driving voltage and another terminal connected to the first node;
a current driving transistor having a gate connected to the first node and one terminal applied with the driving voltage; and
an organic electroluminescent device to be connected to another terminal of the current driving transistor.

17. The organic electroluminescent display of claim 16, wherein the capacitor is charged with the zero data voltage, when the zero data voltage enable signal is applied to the pixel.

18. The organic electroluminescent display of claim 14, wherein the zero data voltage is a panel voltage.

19. The organic electroluminescent display of claim 14, wherein the organic electroluminescent display is an active matrix organic electroluminescent display.

20. A driver of an organic electroluminescent display, the driver comprising:
a circuit to supply precharge voltage which applies a precharge voltage to a pixel circuit of the organic electroluminescent display;
a current digital analog converter which sinks a current corresponding to pixel data that is to be displayed from the pixel circuit, when the pixel data is not zero data; and
a circuit to supply a zero data voltage corresponding to the zero data to the pixel circuit when the pixel data is zero data.

21. The driver of claim 20, further comprising:
a zero data process block which determines whether the pixel data is the zero data.

22. A method of driving an organic electroluminescent display, the method comprising:
receiving pixel data that is to be displayed;
determining whether the pixel data is zero data; and
applying a zero data voltage corresponding to the zero data to a pixel corresponding to the pixel data when the pixel data is zero data.

23. The method of claim 22, wherein the organic electroluminescent display is driven by a current sink method.

24. The method of claim 23, further comprising:
activating a scan line where the pixel is located; and
precharging the pixel with a precharge voltage.

25. The method of claim 24, wherein the precharge voltage is not equal to the zero data voltage.

26. The method of claim 23, further comprising:
sinking a current corresponding to the pixel data when the pixel data is not zero data.

27. A driver of an organic electroluminescent display, the driver comprising:
a first circuit to supply a current to a pixel circuit when pixel data is not zero data; and
a second circuit to supply a zero data voltage to the pixel circuit when the pixel data is zero data.

28. The driver of claim 27, wherein the first circuit generates the current according to a current sink method.

29. The driver of claim 27, wherein the second circuit does not generate the voltage according to a current sink method.

30. The driver of claim 27, wherein the first circuit and the second circuit generate the current and the zero data voltage according to different methods.

31. The driver of claim 27, further comprising:
a data line connected to the panel circuit,
wherein the first circuit is connected between a first power source and the data line to supply the current to the data line, and the second circuit is connected between a second power source and the data line to supply the zero data voltage to the data line.

32. An organic electroluminescent display, comprising:
a panel circuit to drive a panel; and
a driver connected to the panel circuit, the driver comprising:
a first circuit to supply a current to a pixel circuit when pixel data is not zero data; and
a second circuit to supply a zero data voltage to the pixel circuit when the pixel data is zero data.

33. A driver of an organic electroluminescent display, the driver comprising:
a zero data process block which outputs a zero data voltage enable signal when pixel data that is to be displayed is zero data;
a circuit to transmit a zero data voltage corresponding to the zero data to a pixel circuit in response to the zero data voltage enable signal;
a circuit to supply precharge voltage to the pixel circuit according to the pixel data; and
a current digital analog converter which sinks a current corresponding to the pixel data that is to be displayed from the pixel circuit, when the pixel data is not zero data.

34. An organic electroluminescent display, comprising:
a panel circuit to drive a panel; and
a driver connected to the panel circuit, the driver comprising:
a zero data process block which outputs a zero data voltage enable signal when pixel data that is to be displayed is zero data;
a circuit to transmit a zero data voltage corresponding to the zero data to a pixel circuit in response to the zero data voltage enable signal;
a circuit to supply precharge voltage to the pixel circuit according to the pixel data; and
a current digital analog converter which sinks a current corresponding to the pixel data that is to be displayed from the pixel circuit, when the pixel data is not zero data.
